(19) United States
(12) Patent Application Publication
(10) Pub. No.: US 2005/0008976 A1
(43) Pub. Date: Jan. 13, 2005

(54) Method of manufacturing an electronic device

(76) Inventors: Toshio Sakamizu, Tokyo (JP); Hiroshi Fukuda, Kodaira (JP); Hiroshi Shiraishi, Hachioji (JP)

Correspondence Address: REED SMITH LLP, Suite 1400, 3110 Fairview Park Drive, Falls Church, VA, 22042, US

(21) Appl. No.: 10/869,892

(22) Filed: Jun. 18, 2004

(30) Foreign Application Priority Data
Jul. 7, 2003 (JP) 2003-192757

(51) Int. Cl. B08B 3/00; G03C 5/00

(52) U.S. Cl. 430/311; 430/269; 430/331

(57) ABSTRACT

To form a fine resist pattern without collapse, the invention patterns a resist by applying a resist composition to a substrate to form a resist film, exposing the resist film to radiation in a desired pattern, and developing the exposed resist film using supercritical carbon dioxide at 200 atm or lower. The resist composition mainly includes a polymer having a solubility parameter equal to or lower than that of supercritical carbon dioxide.

### CLAIM OF PRIORITY

The present application claims priority from Japanese application JP 2003-192757 filed on Jul. 7, 2003, the content of which is hereby incorporated by reference as if set forth in the entirety herein.

### FIELD OF THE INVENTION

The present invention relates to electronic devices such as semiconductor integrated circuits, micromachines, magnetic disks and optical disks, and, more specifically, to electronic devices and manufacturing methods thereof.

### BACKGROUND OF THE INVENTION

With increasing package density and decreasing size of semiconductor integrated circuits, it has been necessary to develop radiation sources for use in lithography having ever-decreasing wavelengths, from i-line (365 nm) to KrF excimer laser (248 nm), and ArF excimer laser (193 nm), to F₂ excimer laser (157 nm). In addition, lithography techniques using extreme ultraviolet (EUV), electron beams and X-rays are now developing. Resist patterns with a minimum feature size of 0.2 μm to 0.1 μm are formed in current technologies, and those with a minimum feature size less than 0.1 μm are soon to be formed in leading-edge technologies.

A resist may be patterned by applying a film of the resist to a substrate, selectively exposing the resist film to radiation to form a latent image of a predetermined circuit pattern, and removing unexposed portions or exposed portions of the resist to thereby develop the latent pattern. Further, the developed resist is rinsed by immersing in a rinsing agent to terminate development and to rinse the substrate. The aspect ratio (a ratio of the height to the width of a pattern) of a resulting resist pattern increases with a decreasing size of the pattern. With reference to FIG. 6, collapse in line patterns typically occurs upon drying of the rinsing agent (see Journal of the Electrochemical Society, 147(7), p. L115-L116 (1993)). Pattern collapse occurs at a high aspect ratio (e.g., 4), not only in wiring patterns at a pitch of 1:1 but also in gate patters at a relatively large pitch of 1:3.

In conventional development, water is used as the rinsing agent. Water has a high surface tension of 72 mN/m, and thereby causes tensile stress on side walls of the pattern when it remains resting on a fine pattern. The tensile stress is speculated to induce the pattern collapse upon removal of the water during drying. Pattern collapse prevents the formation of a target pattern when fine patterns are arranged small intervals, as in semiconductor integrated circuits, and thus leads to decreased yields of products and retards the downsizing of microstructures.

In an attempt to solve this problem, the developed resist pattern may be rinsed with a rinsing agent having a low surface tension. For example, it has been reported that pattern collapse can be inhibited by using a rinsing agent of water and a polyoxyethylene ether, which has a low surface tension (see The Institute of Electronics, Information and Communication Engineers (IEICE), Technical Report SDM 93-114, p. 33-39). However, the rinsing agent affects the solubility of the resist, thus inviting undesired shape of the resist pattern due to the use of certain rinsing agents. To address this issue, JP-A No. 266358/1995 discloses a technique of replacing a rinsing agent with a perfluoropolyalkyl polyether, which provides a low surface tension of about 12 mN/m before drying. This technique can reduce pattern collapse to some extent, but does not prevent it, since the remaining liquid still causes surface tension.

Supercritical fluids such as methanol, ethanol, water and carbon dioxide do not provide significant surface tension when used as rinsing agents. Supercritical carbon dioxide has a critical temperature near to room temperature, shows no toxicity or combustibility, occurs abundantly in nature, is inexpensive and is widely used. Such a supercritical fluid has properties between a gas and a liquid, and has a viscosity and tension nearer to a gas, and thus causes substantially no surface tension. For example, JP-A No. 315241/1993 and JP-A No. 138156/2000 describe that ultrafine patterns can be formed with a high aspect ratio by drying a resist in supercritical carbon dioxide (see FIG. 7).

A conventional resist may be dried using supercritical carbon dioxide, such as by replacing a rinsing agent with carbon dioxide and drying the resist pattern in supercritical carbon dioxide (see FIG. 8A). If the rinsing agent used is water, carbon dioxide is substantially insoluble in water and thus water often remains among the pattern on the substrate. Thus, pattern collapse caused by the surface tension of water occurs if water is used in a supercritical drying process.

Thus, the need exists to form a fine resist pattern in a semiconductor process without collapse, and without the difficulties encountered in known methods.

### SUMMARY OF THE INVENTION

The present invention provides a radiation-sensitive composition that can be developed to provide a high-aspect ratio pattern at high resolution, by using supercritical or near-supercritical carbon dioxide, and a method of manufacturing an electronic device using the same.

A resist that has been exposed to radiation may be exposed to a development process using a supercritical fluid. FIG. 8B shows a flow chart of a supercritical development process, in which the resist is exposed to radiation using a conventional lithographic apparatus, the substrate carrying the exposed resist is placed in a supercritical developing apparatus, and the resist is then developed, rinsed and dried therein. In the drying procedure, carbon dioxide in gas state is released out of a chamber.

FIG. 9 illustrates a supercritical development process and shows the relationship between the pressure of a chamber and the time at which carbon dioxide may be used as a supercritical fluid. Liquid carbon dioxide reaches its supercritical pressure and becomes a supercritical fluid at 73 atm when the temperature is at 31° C. The resist pattern may be developed at a pressure higher than the critical pressure, such as 100 to 200 atm, for a predetermined time, and may be rinsed at 73 atm. Upon reducing the pressure, the supercritical carbon dioxide is converted into a gas state and may released out of the chamber. Thereby, the resist pattern is dried.

The base resin of the resist may be dissolved in the supercritical fluid. A solubility parameter, δ, of a resin can be used as an index for the solubility of the resin in a supercritical fluid. More specifically, a resin having a solubility parameter δp equal to or lower than the solubility parameter δs of a supercritical fluid is soluble in the supercritical fluid. A resist composition mainly containing such a resin may yield a negative pattern at high resolution without swelling.

More specifically, the present invention may provide, in an aspect, a method of manufacturing an electronic device, including the steps of preparing a substrate; applying a resist composition including a polymer to the substrate to form a resist film; selectively exposing the resist film to radiation in a predetermined pattern; and developing the patterned resist to form a resist pattern. The polymer may have such a molecular weight as to have a solubility parameter δ equal to or lower than the solubility parameter of supercritical carbon dioxide, and the step of developing may use supercritical carbon dioxide at a pressure of 200 atm or less.

The present invention may provide, in another aspect, a method of manufacturing an electronic device including the steps of preparing a substrate; applying a resist composition containing a polymer to the substrate to form a resist film; selectively exposing the resist film to radiation in a predetermined pattern; and developing and rinsing the patterned resist using a supercritical fluid to form a resist pattern, wherein the step of developing and rinsing includes the steps of: developing the patterned resist at a first pressure at which liquid carbon dioxide is converted into a supercritical fluid; rinsing the developed resist at a second pressure lower than the first pressure; and further reducing the pressure.

According to an aspect of the present invention, resist patterns may be formed at a high resolution and a high aspect ratio by exposing to actinic rays such as visible radiation, ultraviolet radiation, far-ultraviolet radiation, vacuum ultraviolet radiation, extreme ultraviolet, X-rays, ionic rays and electron beams. The exposed resist film may be developed in a supercritical fluid, and may thus yield a resist pattern without pattern collapse, since no surface tension acts upon the resist in such a supercritical fluid. Such a manufacturing method may be free from waste treatment of water and developer, and thus may be free of environmental pollution and is thus advantageously used in micromachining for manufacture of semiconductor devices, such as ICs and LSIs.

Thus, the present invention provides a fine resist pattern in a semiconductor process without collapse, and without the difficulties encountered in known methods.

### BRIEF DESCRIPTION OF THE DRAWINGS

The various features of the present invention will now be described in greater detail with reference to the drawings of aspects of the present invention, and various related elements thereof, wherein like reference numerals designate like elements, and wherein:

FIG. 1 is a diagram showing a relationship between the solubility parameter δs and the density of supercritical carbon dioxide;

FIG. 2 is a graph showing a relationship between the pressure and the highest molecular weight of a polymer soluble in the supercritical fluid;

FIG. 3 is a schematic diagram of a supercritical resist developing apparatus;

FIG. 4 is a graph showing the sensitivity of a resist used in Example 1;

FIG. 5 is a schematic sectional view of a MOS transistor;

FIGS. 6A and 6B are diagrams showing pattern collapse occurring in conventional techniques;

FIGS. 7A and 7B are diagrams showing a pattern formation using a supercritical fluid;

FIGS. 8A and 8B are process charts of a supercritical drying process for alkali-developable resists, and of a supercritical developable resist process, respectively;

FIG. 9 is a diagram showing a relationship between the time and pressure in a supercritical developing process;

FIG. 10 shows a molecular weight distribution of a polystyrene having a degree of dispersion of 1.5 or less;

FIGS. 11A through 11G are diagrams showing a gate patterning process; and

FIGS. 12A through 12G are diagrams showing a MEMS forming process.

### DETAILED DESCRIPTION

It is to be understood that the figures and descriptions of the present invention have been simplified to illustrate elements that are relevant for a clear understanding of the present invention, while eliminating, for purposes of clarity, many other elements found in a typical semiconductor device and method. Those of ordinary skill in the art will recognize that other elements are desirable and/or required in order to implement the present invention. But because such elements are well known in the art, and because they do not facilitate a better understanding of the present invention, a discussion of such elements is not provided herein. The disclosure herein is directed to all such variations and modifications to the applications, networks, systems and methods disclosed herein and as will be known, or apparent, to those skilled in the art.

The solubility parameter is widely used as an index of the polarity of a solvent, and a solvent evidences an increasing polarity with an increasing solubility parameter. The solubility parameter, 5, can be determined by calculation according to following Equation (1):
δ(cal·cm⁻³)^{1/2}=DΣG/M,
wherein D is a density (g/cm³); ΣG is a sum of molar-attraction constants G (cal^{1/2}·cm^{2/3}·mol⁻¹); and M is a molecular weight (see CRC Handbook of Chemistry & Physics, 59th Ed., p. C-726 to C-727). Supercritical carbon dioxide is often treated as having a polarity similar to hexane, i.e., as having a solubility parameter, δs, of 7.3, and carbon dioxide changes its 6s in supercritical state with a varying pressure.

The solubility parameter, δs, of a supercritical fluid can be determined by calculation according to following Equation (2):
δs=1.25P_{c}^{0.5}[ρ/ρ_{L}],
wherein P_{c} is a critical pressure (73 atm in the case of carbon dioxide), ρ is a density of the supercritical fluid; and ρ_{L} is a density of the supercritical fluid in liquid state (0.87 in the case of carbon dioxide) [see Advances in Chromatography, Kikan Kagaku Sosetsu (1990), 9, The Chemical Society of Japan]. The relationship between the pressure and the density, ρ, is indicated by a phase diagram of carbon dioxide [see Advances in Chromatography, Kikan Kagaku Sosetsu (1990), 9, p. 132, The Chemical Society of Japan].

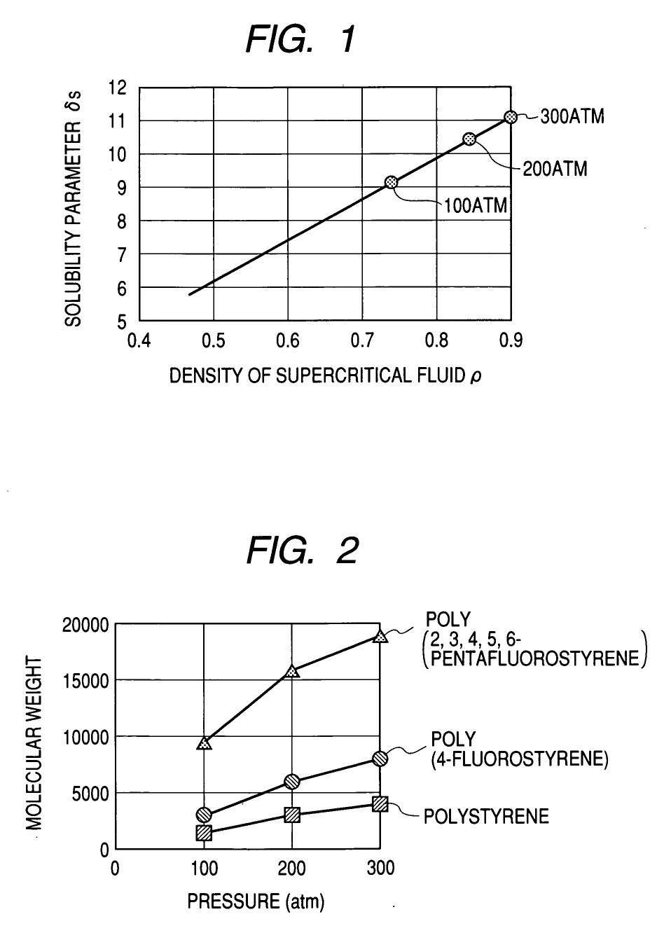

FIG. 1 shows the relationship between the solubility parameter, δs, and the density (pressure) of supercritical carbon dioxide at a constant temperature of 36° C. The solubility parameter, δs, is about 9, 10.5 and 11, at pressures of 100 atm, 200 atm and 300 atm, respectively. Thus, a polymer having a higher polarity can be dissolved in a supercritical fluid at higher pressure. However, the upper limit of the pressure to be used in resist development is generally about 200 atm. This upper limit is generally derived as a limitation in an apparatus.

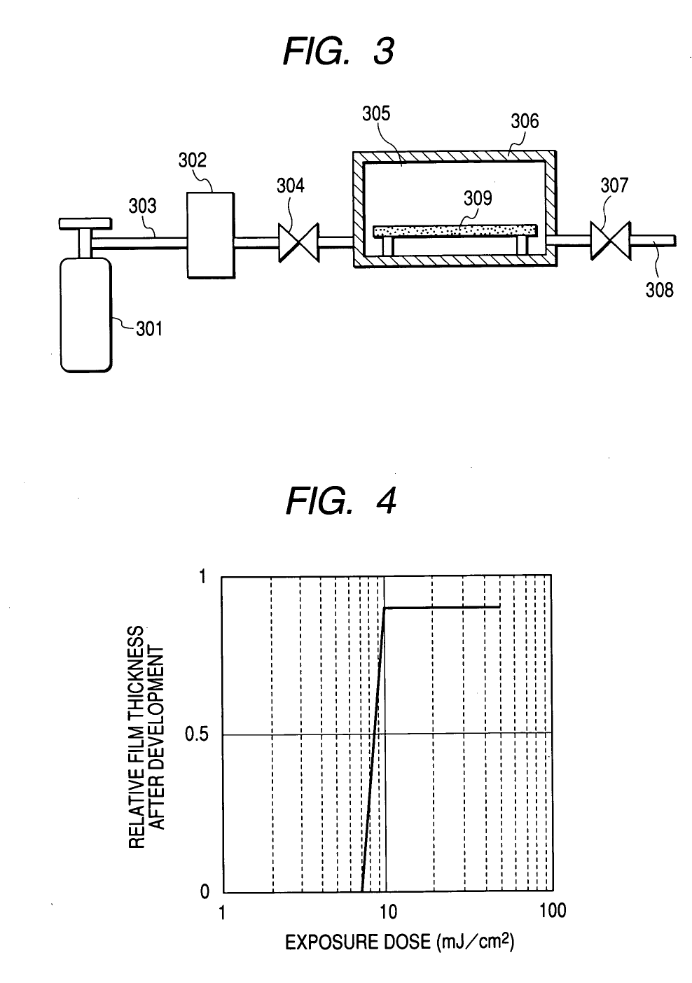

FIG. 3 is a schematic diagram of a resist developing apparatus. This apparatus includes a compressed CO₂ cylinder 301, a high pressure pump 302, pipe laying 303, a flow rate control valve 304, a cylindrical high-pressure chamber 305 and a thermoregulator 306. The compressed CO₂ cylinder 301 and the high pressure pump 302 are connected via the pipe laying 303 to a high-pressure chamber 305 in which a substrate 309 may be present. The flow rate control valve 304 may be arranged midway along the pipe laying 303, and may work to control the flow rate of carbon dioxide. The thermoregulator 306 surrounds the high-pressure chamber 305. Carbon dioxide is fed into the high-pressure chamber 305 and is released therefrom through an outlet 308. A dry pipe for removing moisture in carbon dioxide, and a filter for preventing contamination of oil mist from the compressor, may be arranged immediately upstream of the high-pressure chamber 305. The upper limit of the pressure may be dependent in part on available low-cost parts that are resistant to a pressure of about 200 atm. Of course, one skilled in the art will recognize that the apparatus may be configured to be used at pressures exceeding 200 atm, but such a configuration would, of course, significantly increase unit cost.

Further, for example, a resist process at high pressure, e.g., 300 atm, may cause deterioration in the shape of the resulting pattern, due to the extraction of components, such as a photosensitizer and additives, in the resist composition. For example, when the pressure is rapidly reduced from 300 atm to 1 atm, the pattern swells. If the pressure is gradually reduced to avoid a swelled pattern, the throughput decreases.

When the resist composition according to the present invention is developed at a pressure of 200 atm or less, the pattern shape due to the extraction of resist components in the resist is not observed. This is, at least in part, because the structure of the base resin used in the present invention and the resin structure in the exposed resist portions work to suppress the extraction of the resist components, and thereby suppress deterioration in pattern shape. In addition, the pattern swelling upon rapid reduction of pressure does not occur when the resist composition of the present invention is used at a pressure of 200 atm or less.

Carbon dioxide becomes a gas upon reduction of pressure, and thus may cause the swelling of a resin film upon reduction of pressure. Thus, the resist composition and development process according to the present invention provide a patterning process that produces high resolution and high aspect ratio with a high throughput.

The solubility parameter, δp, of a polymer varies with varying interactions (cohesive forces), and entanglement between polymer chains, and thus cannot be precisely determined according to Equation (1). However, the monomer structure of a resin is believed to be closely associated with the solubility in supercritical carbon dioxide. For example, a poly (tetrafluoroethylene) has a low interaction between polymer chains, is soluble in supercritical carbon dioxide, and has a very low solubility parameter δp of 6.2 (see Solution and Solubility 3rd Ed., p. 132, MARUZEN CO., LTD.). Among halogens, fluorine has a very low molar-attraction constant of about one fifth that of the hydroxyl group and chlorine, and of about one eighth that of the ester group (see Koubunshi Data Handbook Kisohen, p. 594, BAIFUKAN CO., LTD.).

Accordingly, the solubility parameter δp of a polymer containing neither hydrogen bonds nor a substituent therefor to enhance the interaction between polymer chains may be estimated as a total sum of monomer factors and polymer chain length (molecular weight) factors. Thus, the solubility parameter δp of a polymer can be determined by calculation according to following Equation (3):
δp=δm+[K×(number of chains)],
wherein δm is a solubility parameter of the monomer; and K is a constant. The constant K can be determined by determining the critical molecular weight (highest molecular weight) of the polymer soluble in a supercritical fluid at a varying pressure applied to the supercritical fluid, i.e., at a varying δs.

With regard to the relationship between the critical molecular weight and the constant K, for monodisperse polystyrenes having a degree of dispersion of 1.5 or less and having different molecular weights, FIG. 10 shows a molecular weight distribution of such polystyrenes having a degree of dispersion of 1.5 or less. FIG. 2 shows relationships between the pressure and the critical molecular weight, and illustrates that a polystyrene having a low molecular weight may be dissolved in supercritical carbon dioxide, and the critical molecular weight of such a polystyrene will increase with an increasing pressure. The polystyrene illustrated is a styrene monomer having a solubility parameter δm of 9.0, a density of 0.91, a molecular weight of 104.2 and a sum ΣG of 1036. The critical molecular weight of the polystyrene is at 1500 (number of chains: 15) at 100 atm, 3000 (number of chains: 30) at 200 atm, and 4000 (number of chains: 40) at 300 atm. The constant K is estimated at 0.04, based on these results. The estimated constant K is applied to poly (4-fluorostyrene), a polystyrene derivative, and the critical molecular weight soluble at a varying pressure (FIG. 2) was measured to determine the solubility parameter δp. The solubility parameter δm of 4-fluorostyrene monomer is 8.4, and the molar-attraction constant of fluorine is 60. As a result, the poly (4-fluorostyrene) has a solubility parameter δp equal to or lower than the solubility parameter δs of the supercritical fluid (supercritical carbon dioxide).

With reference to FIG. 2, the same procedure as is discussed immediately hereinabove is repeated on poly (2,3,4,5,6-pentafluorostyrene), a polystyrene derivative having plural fluorine atoms in its monomer unit, on a polynorbornene derivative of the following Formula (1), and on an alicyclic polymer, and it was found that these polymers each have a solubility parameter δp equal to or lower than the solubility parameter δs of the supercritical fluid. The monomer 2,3,4,5,6-pentafluorostyrene has a solubility parameter δm of 7.0. The norbornene derivative monomer has a solubility parameter δm of 6.8 and a molecular weight of 196.25, and the polynorbornene derivative has a solubility parameter δp of 7.8 at a molecular weight of 5000.

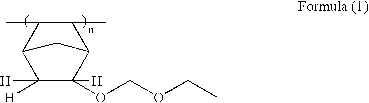

Examples of polymers satisfying the above requirement are monodisperse polystyrenes having a degree of dispersion of 1.5 or less and a molecular weight of 3000 or less; homopolymers or styrenic copolymers of monomers each having one or more fluorine atoms, such as poly (4-fluorostyrene), poly (3-fluorostyrene) and poly (α,β,β-trifluorostyrene), of the following Formula (2); homopolymers or copolymers of styrene derivatives each having at least one substituent, such as trimethylsilyl ether group, triethylsilyl ether group, t-butyldimethylsilyl ether group and other silyl ether groups, alkyl ether groups, acetal groups and ketal groups; and copolymers between styrene and at least one of these styrene derivatives. Examples of the polynorbornene derivatives include homopolymers and copolymers of norbornene derivatives each containing neither a hydroxyl group nor an ester group. Examples of norbornene derivatives are those containing an ether group, such as hexafluoroisopropyl ether group, acetal group, ketal group or silyl ether group. Examples of polymers for use in the present invention also include copolymers between any of the norbornene derivatives and another alicyclic compound, and copolymers between any of the norbornene derivatives and tetrafluoroethylene.

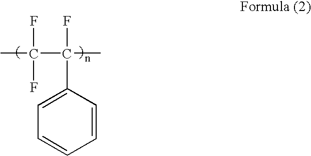

Cyclic molecules having very little entanglement in polymer chains, and such molecules having a molecular weight of 3000 or less may also be used in the present invention. Examples of such cyclic molecules are compounds corresponding to calixarene derivatives, if the hydroxyl groups of such cyclic molecules are replaced with ether groups, such as silyl ether group, alkyl ether groups, alkyl ether halide groups, acetal groups or ketal groups, such as 5,11,17,23,29,35-hexachloromethyl-37,38,39,40,41,42-hexamethoxycalix[6]arene of the following Formula (3). Examples of other calixarene derivatives include 5,11,17,23-tetrakis (chloromethyl)-25,26,27,28-tetrahydroxycalix[4]arene, 4-t-butylcalix[4]arene, 4-t-butylcalix[5]arene, 4-t-butylcalix[6]arene, 4-t-butylcalix[8]arene, calix[4]arene, calix[6]arene and calix[8]arene. Examples of polymers also include spherical dendrimer molecules, compounds corresponding to poly (benzyl ether) dendrimers, if the hydroxyl groups of such are replaced with ether groups, as well as hyperbranched polymers containing neither a hydroxyl group nor an ester group.

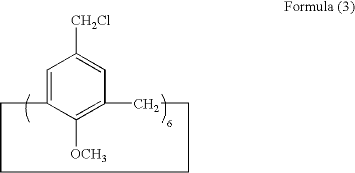

Fluorine-containing polystyrene has an increasing solubility in a supercritical fluid as an increasing number of fluorine atoms are substituted thereon. However, fluorine-containing polystyrene having excessive amounts of fluorine atoms used as a resist may have lowered etching resistance and poor adhesion with a substrate. Such a fluorine-containing polymer is etched at a higher rate than a polymer containing no fluorine atom, and is etched at an increasing rate as the number of fluorine atoms increases. A resist of a fluorine-containing polymer is etched at a rate in proportion to parameter Nt/[Nc-No-Nf], wherein Nt is a number of total atoms; Nc is a number of carbon atoms; No is a number of oxygen atoms; and Nf is a number of fluorine atoms [see Extended Abstracts (The 48th Spring Meeting, 2001), March 2001, p. 737; The Japan Society of Applied Physics and Related Societies].

The relationship between the number of substituted fluorine atoms and the ratio of the etching rate of a polystyrene having substituted fluorine atoms to that of polyhydroxystyrene is such that a polystyrene having three fluorine atoms in its monomer unit has an etching rate 1.2 times that of polyhydroxystyrene, and shows sufficient etching resistance. In contrast, polystyrene having four fluorine atoms in its monomer unit has an increased etching rate about 1.5 times that of polyhydroxystyrene, and thus invites dimensional variation and decreased process margin. Accordingly, the styrene monomer for use herein may have one, two or three fluorine atoms in its structure. Alternatively, the fluorine-containing polystyrene may be of a plurality of different monomers as a repetitive structure, in which the total sum of the products of molar fraction multiplied by the number of fluorine atoms in the plurality of different monomers is 3 or less.

Examples of such copolymers include a copolymer between 2,3,4,5,6-pentafluorostyrene with a molar fraction of 0.5 and 4-fluorostyrene with a molar fraction of 0.5, and a copolymer between 2,3,4,5,6-pentafluorostyrene with a molar fraction of 0.6 and styrene with a molar fraction of 0.4.

In addition to the base resin, the resist composition may further include any of diaryliodonium salts, triarylphosphonium salts, halides, photo radical generators, azide compounds and sulfonic esters. Solvents for use in the present invention include, but are not limited to, methyl cellosolve, ethyl cellosolve, methyl cellosolve acetate, ethyl cellosolve acetate, propylene glycol monomethyl ether acetate, propylene glycol monoethyl ether acetate, methyl methoxypropionate, methyl ethoxypropionate, ethyl lactate, diacetone alcohol, cyclohexanone, 2-heptanone, toluene, xylenes and anisole.

Where necessary, the resist composition may further include surfactants for preventing striation (uneven coating) or improving developing properties, basic compounds and ionic dissociative compounds, such as onium halides, for preventing diffusion of an acid catalyst to unexposed portions, and moisturizers, such as tetraethylene glycol.

The present invention is illustrated hereinbelow with reference to several non-limiting examples.

### EXAMPLES

### Example 1

A resist coating composition having a solid concentration of 20 percent by weight is prepared by dissolving 100 parts by weight of a polystyrene (available from Sigma Aldrich Corporation) having a weight-average molecular weight of 2330 and a degree of dispersion of 1.07 and 20 parts by weight of bis (4-azidophenyl)ether, in methyl cellosolve acetate. The resist coating composition is applied to a silicon wafer by spin coating, is heated at 100° C. for 2 minutes, and yields a resist film 0.5 μm thick. The substrate carrying the resist film is exposed to KrF excimer laser light at a stepwise varying exposure dose. The exposed resist film is then developed, rinsed and dried in a supercritical developing apparatus as shown in FIG. 3.

The supercritical apparatus includes a compressed CO₂ cylinder 301, a high pressure pump 302, pipe laying 303, a flow rate control the flow rate control valve 304, a cylindrical high-pressure chamber 305 and a thermoregulator 306. The compressed CO₂ cylinder 301 and the high-pressure pump 302 are connected via the pipe laying 303 to the high-pressure chamber 305 in which the substrate 309 may be fixed. The flow rate control valve 304 is arranged midway along the pipe laying 303 and works to control the flow rate of carbon dioxide. The thermoregulator 306 surrounds the high-pressure chamber 305. Carbon dioxide enters the high-pressure chamber 305 and is released therefrom through an outlet 308.

In the apparatus, gasified and released carbon dioxide is recovered, converted into liquid carbon dioxide and reused, thus avoiding adverse affects of carbon dioxide on the environment.

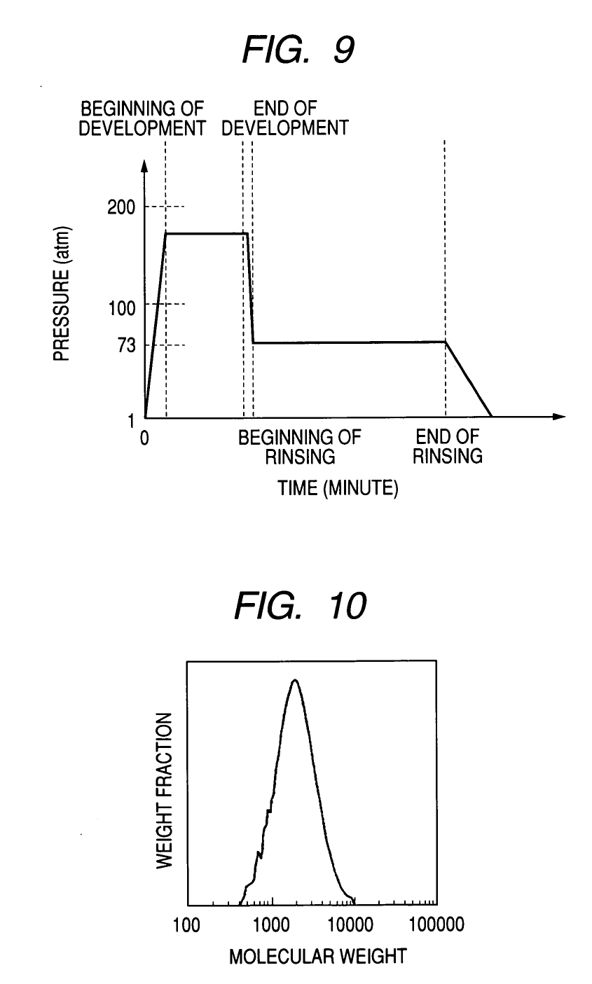

The emission of carbon dioxide is controlled by an emission rate control valve 307. The pressure inside the high-pressure chamber 305 is controlled by controlling the flow rate control valve (carbon dioxide inlet valve) 304 and the emission rate control valve 307. The substrate 309 carrying the exposed resist is fixed in the high-pressure chamber 305 at a temperature of 36° C., near to the critical temperature of 31° C., and the chamber is sealed. By operating the high-pressure pump 302 to open the flow rate control valve 304, carbon dioxide is fed into the high-pressure chamber 305 at a flow rate of 400 ml/min. The pressure inside the high-pressure chamber 305 is controlled by emitting carbon dioxide from the chamber and feeding carbon dioxide at a flow rate higher than the emission rate. The pressure is raised to 200 atm, and the exposed resist film was developed for 2 minutes. Then, the developed substrate is rinsed at a constant temperature of 36° C. at a reduced pressure of 73 atm for 5 minutes (FIG. 9).

In this exemplary procedure, the pressure is reduced to 73 atm by decreasing the flow rate of carbon dioxide fed through the flow rate control valve 304 and increasing the emission rate thereof through the emission rate control valve 307. The substrate is rinsed with another portion of the supercritical fluid, and the used fluid is released from the high-pressure chamber 305.

After rinsing, the flow rate control valve 304 is closed, and carbon dioxide is released at a flow rate of 1 liter per minute at a constant temperature of 36° C. to thereby reduce the pressure to the atmospheric pressure. After the developing procedure, the thickness of a residual resist film in an exposed portion is determined, and the sensitivity properties are determined based on the relationship between the thickness of residual film and the exposure dose. The resist composition according to this exemplary embodiment of the present invention yields a resist pattern with a high contrast at a high sensitivity of 10 mJ/cm² (FIG. 4).

A 0.15-μm line-and-space pattern is formed on a substrate carrying a film of the resist composition using an electron beam lithography system at an acceleration voltage of 75 kV and at an exposure dose of 20 μC/cm². The exposed resist film is developed by the above procedure and yields a target pattern without collapse and swelling. The substrate may be developed under critical conditions at high pressure of 200 atm. If it is developed at a low pressure of 150 atm or less, a large amount of scum is formed and a satisfactory device may not be prepared.

### Example 2

A resist coating composition is prepared, is applied to a substrate, and is exposed to electron beams by the procedure of Example 1, except that a poly (4-fluorostyrene) having a weight-average molecular weight of 6000 and a degree of dispersion of 1.4 is used instead of polystyrene. The exposed resist film is then developed at 36° C. at 150 atm, lower than that in Example 1, and is rinsed at 31° C. at 73 atm. A pattern is formed at an electron beam exposure dose of 15 μC/cm², a higher sensitivity than Example 1, without scum.

### Example 3

A resist composition is prepared, is applied to a substrate, and is exposed to electron beams by the procedure of Example 1, except that a poly (α,β,β-trifluorostyrene) having a weight-average molecular weight of 6000 and a degree of dispersion of 1.3 is used instead of polystyrene. The exposed resist film is developed under the conditions of Example 2. A fine pattern is formed at a higher sensitivity by an electron beam exposure dose of 10 μC/cm² without scum.

### Example 4

The procedure of Example 1 is repeated, except that, instead of polystyrene, a compound obtained by acetalization with chloromethyl ethyl ether of all the hydroxyl groups of 5,11,17,23-tetrakis (chloromethyl)-25,26,27,28-tetrahydroxycalix[4]arene having a molecular weight of 618.4 (available from Sigma Aldrich Corporation) is used. A result similar to that in Example 1 is obtained.

### Example 5

The procedure of Example 1 is repeated, except that a copolymer of styrene and 2,3,4,5,6-pentafluorostyrene having monomer fractions of 0.4 and 0.6, respectively, with a total sum of the products of molar fraction multiplied by number of fluorine atoms of 3, and a weight-average molecular weight of 6000 and a degree of dispersion of 1.4, is used. The result obtained is similar to that of Example 1. The resist may be patterned at a low pressure of 90 atm without resist scum, due to decreased solubility in the supercritical fluid, thereby illustrating that 2,3,4,5,6-pentafluorostyrene is useful as a comonomer and may be used at a molar fraction of 0.6 or less.

### Example 6

A resist coating composition having a solid concentration of 20 percent by weight is prepared by dissolving 100 parts by weight of a copolymer, 4 parts by weight of dimethylphenylsulfonium triflate as an acid generator, and 0.05 parts by weight of dicyclohexylamine in propylene glycol monomethyl ether acetate. The copolymer is a 1:1 copolymer between norbornylene and 5-ethoxymethoxy-bicyclo[2.2.1]hept-2-ene, a norbornene derivative monomer containing an acetal group, and has a weight-average molecular weight of 4000 and a degree of dispersion of 1.3. After forming an antireflection coating of an organic compound on a silicon substrate, the resist coating composition is applied thereto by spin coating, is heated at 100° C. for 2 minutes, and yields a resist film 0.5 μm thick. The resist film is then selectively exposed to ArF excimer laser light through a mask carrying a predetermined pattern to form a latent pattern. The exposed resist film is then heated at 100° C. for 90 seconds and is developed by the procedure of Example 1. As a result, a 0.15-μm line-and-space pattern is formed without collapse or swelling.

### Example 7

The procedure of Example 6 is repeated, but a 1:1 copolymer between tetrafluoroethylene and 5-ethoxymethoxy-bicyclo [2.2.1]hept-2-ene, an acetal-containing norbornene derivative monomer, having a weight-average molecular weight of 6000 and a degree of dispersion of 1.3, is used instead of the copolymer of Example 6. As a result, a 0.15-μm line-and-space pattern is formed without collapse or swelling as in Example 6.

### Example 8

A resist coating composition having a solid concentration of 20 percent by weight is prepared by dissolving 100 parts by weight of a compound, 4 parts by weight of tri-substituted ethanesulfonic acid ester obtained from pyrogallol as an acid generator, and 0.1 part by weight of tetraethylphosphonium iodide in 2-heptanone. The compound is prepared by acetalization with chloromethyl ethyl ether of all hydroxyl groups of calix[8]arene (available from Sigma Aldrich Corporation), which has a molecular weight of 849. The resist coating composition is applied to a silicon substrate, is heated at 100° C. for 2 minutes, and yields a resist film 0.5 μm thick. A 0.15-μm line-and-space pattern is formed on the resist film at an exposure dose of 20 μC/cm² using an electron beam lithography system at an acceleration voltage of 75 kV. After patterning, the substrate is heated at 100° C. for 120 seconds to accelerate an elimination reaction of the acetal groups by catalysis of the acid catalyst, thereby forming hydroxyl groups. The substrate is then developed by the procedure of Example 1, and a similar result to that of Example 1 may be obtained.

### Example 9

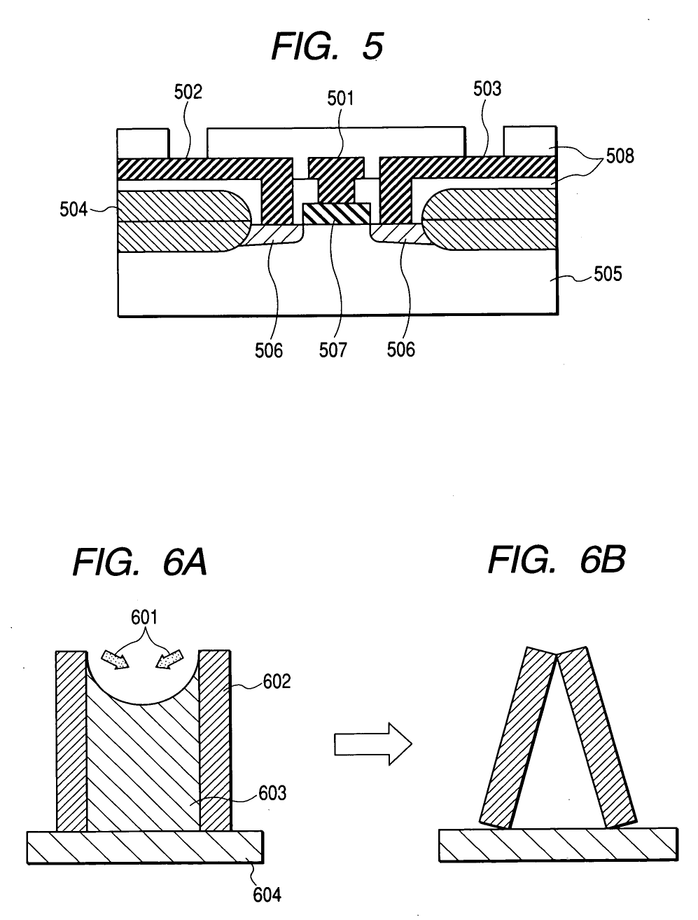

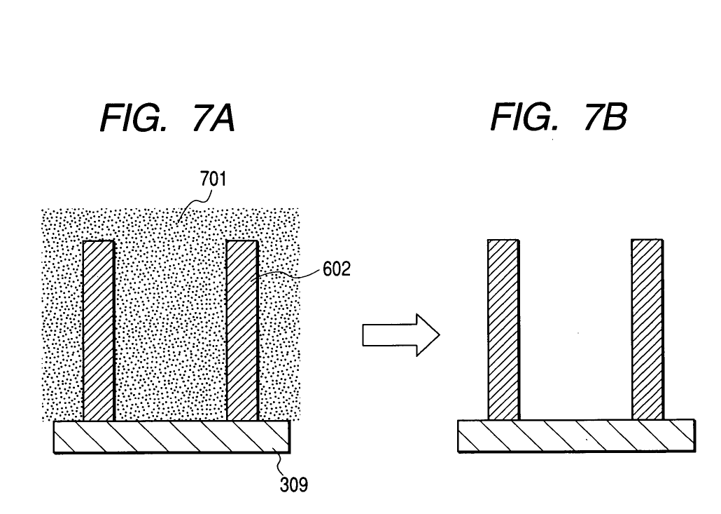

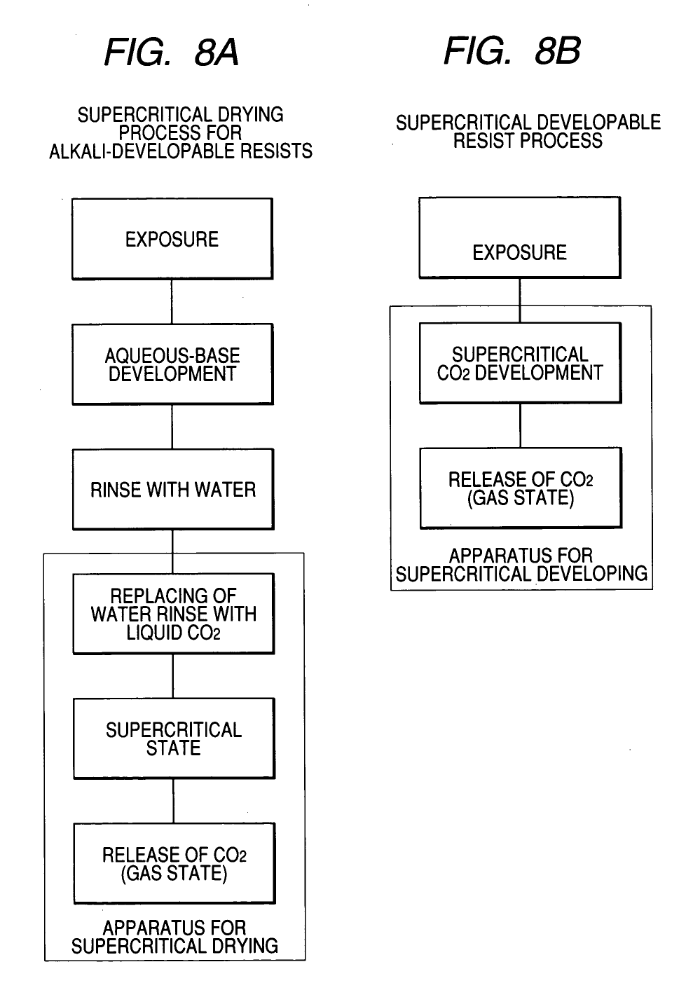

FIG. 5 is a schematic sectional view of a metal-oxide-semiconductor (MOS) transistor prepared according to the present invention. In the MOS transistor, a voltage applied to a gate electrode 501 controls a drain current passing through a source electrode 502 and a drain electrode 503. The method for preparing this structure includes several processes, such as a formation process of field oxide film, formation process of gate layer and formation process of wiring layer. The formation process of the field oxide film may include a formation process of a resist pattern on a silicon nitride film.

An oxide film 50 nm thick is formed on a p-type silicon wafer according to a conventional procedure, and a silicon nitride film 200 nm thick is formed thereon by plasma chemical vapor deposition (plasma CVD). A negative resist pattern, including a 0.2-μm isolated pattern, is formed on the substrate using the resist coating composition and procedure of Example 6. Next, the silicon nitride film is patterned using the resist pattern as a mask according to a conventional dry etching procedure. The field oxide film 504 is then formed according to a conventional procedure. The silicon nitride film is etched, a gate is oxidized, and a polycrystalline silicon film is grown to form a gate layer. A 0.15-μm line resist pattern is formed on the resulting substrate by the patterning procedure of Example 6.

The polycrystalline silicon is etched according to a conventional procedure using the resist pattern as a mask to form the gate electrode 501. The source and drain thin oxide films are etched, arsenic is doped into the polycrystalline silicon gate source and drain regions, and oxide films are yielded. Contact holes for aluminium wiring to the gate, source and drain are formed, a tungsten film is formed by vapor deposition, and the wiring pattern 505 is then formed, followed by the formation of a protective film and pads for bonding. Thus, the exemplary MOS transistor shown in FIG. 5 is prepared. In the present example, the present invention formed the field oxide film and the gate layer, and it will be apparent to those skilled in the art based on this illustrative embodiment that the present invention may also be applied to other manufacturing methods and processes for semiconductor devices.

### Example 10

A gate patterning process of a large-scale integrated circuit (LSI) having a MOS transistor is illustrated with reference to FIGS. 11A through 11G.

An oxide film 508 having a thickness of 50 nm is formed on a p-type silicon wafer 612 according to a conventional procedure, and a silicon nitride film 610 having a thickness of 200 nm is formed thereon by plasma CVD (FIG. 11A).

A negative resist pattern 602 including a 0.2-μm isolated pattern is formed on the substrate 612 using the resist coating composition and procedure of Example 6 (FIG. 11B). Next, the silicon nitride film 610 is patterned using the resist pattern 602 as a mask according to a conventional dry etching procedure (FIG. 11C). The field oxide film 504 is then formed (FIG. 11D). The silicon nitride film 610 is etched, a gate is oxidized, and a polycrystalline silicon 613 is grown (FIG. 11E). A 0.15-μm line resist pattern 602 is formed on the resulting substrate by the patterning procedure of Example 6 (FIG. 11F). The polycrystalline silicon is etched according to a conventional procedure using the resist pattern 602 as a mask to form a polycrystalline silicon gate 615 (FIG. 11G).

### Example 11

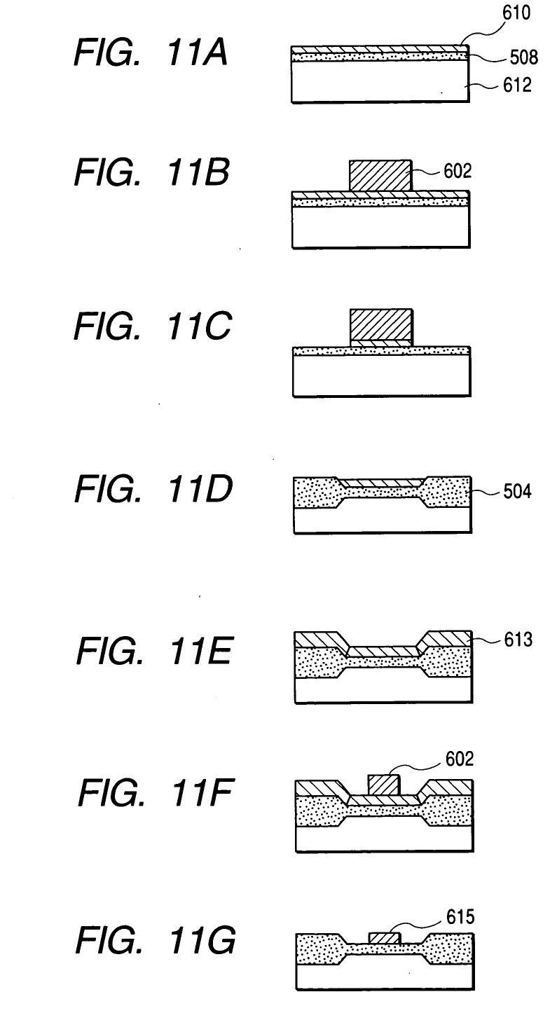

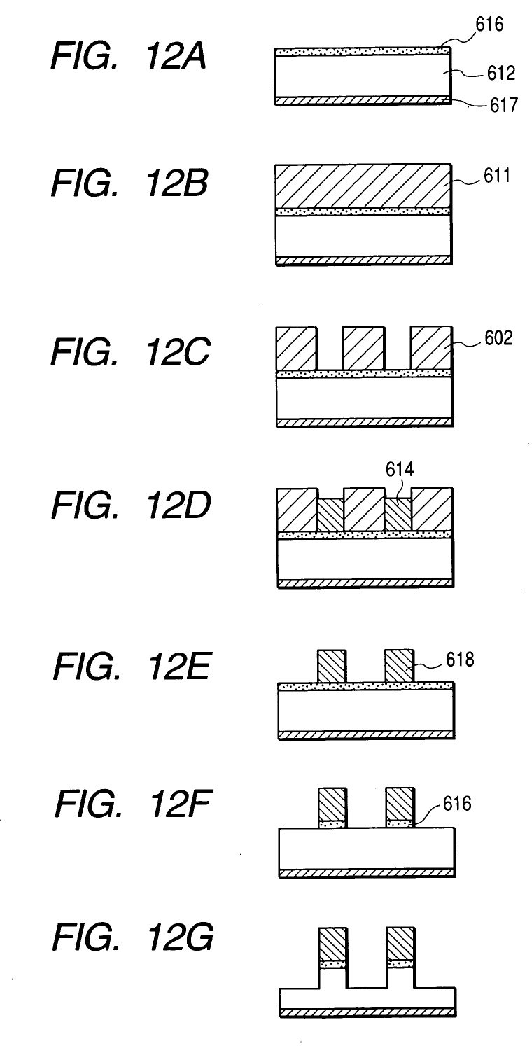

FIGS. 12A through 12G illustrate application of the present invention to a micro electro mechanical system (MEMS), wherein a fine structure having a high aspect ratio is manufactured. The manufactured fine structure can be used as a micro mould in the production of three-dimensional structures, such as micro motion mechanisms and pressure or acceleration sensors, for example, such as by injection molding of plastics or granular materials.

On a silicon substrate 612 is formed a chromium film 616 having a thickness of 50 nm on one side and a gold film 617 having a thickness of 50 nm on the other side, by sputtering. The resist coating composition of Example 1 is applied to the chromium film 616 to form a resist film 611 having a thickness of 20 μm. The resist film 611 is then exposed to X-rays from synchrotron radiation and is developed using supercritical carbon dioxide to form a 2-μm resist pattern 602. A nickel film 614 is then deposited on the chromium film 616 by electroplating. The resist pattern 602 is then removed to form a nickel pattern 618. The chromium film 616 is then dry-etched using the nickel pattern 618 as a mask, and the substrate 612 is wet-etched to a depth of 30 μm.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A method of manufacturing an electronic device, comprising the steps of:
preparing a substrate;
applying a resist composition at least substantially comprising a polymer to the substrate to form a resist film;
selectively exposing the resist film to radiation in a predetermined pattern; and
developing the patterned resist using supercritical carbon dioxide at a pressure of 200 atm or less to form a resist pattern;
wherein the polymer is of a molecular weight providing a solubility parameter δp equal to or lower than the solubility parameter δs of supercritical carbon dioxide.

2. A method of manufacturing an electronic device, comprising the steps of:
preparing a substrate;
applying a resist composition principally comprising a polymer to the substrate to form a resist film;
selectively exposing the resist film to radiation in a predetermined-pattern; and
developing and rinsing the patterned resist using a supercritical fluid to form a resist pattern, wherein said developing and rinsing comprises the steps of:
developing the patterned resist at a first pressure at which liquid carbon dioxide is a supercritical fluid;
rinsing the developed resist at a second pressure lower than the first pressure; and
further reducing the second pressure.

3. The method according to claim 2, wherein the first pressure is at least 73 atm at 31° C.

4. The method according to claim 2, wherein the first pressure is from about 100 to about 200 atm.

5. The method according to claim 2, wherein the resist composition comprises a monodisperse polystyrene having a molecular weight of 3000 or less and a degree of dispersion of 1.5 or less.

6. The method according to claim 2, wherein the resist composition comprises a nonlinear polymer having a molecular weight of 3000 or less.

7. The method according to claim 2, wherein the resist composition comprises a fluorine-containing polystyrene having a molecular weight of 10000 or less, and comprises a styrene monomer, the styrene monomer structurally having one to three fluorine atoms.

8. The method according to claim 7, wherein the fluorine-containing polystyrene has the one to three fluorine atoms on its principal chain and/or its benzene rings.

9. The method according to claim 7, wherein the fluorine-containing polystyrene comprises a plurality of different monomers as a repetitive structure, and wherein the total of the products of a molar fraction multiplied by a number of fluorine atoms in the plurality of different monomers is 3 or less.

10. The method according to claim 2, wherein the resist composition comprises a polynorbornene derivative having a molecular weight of 5000 or less and contains neither a hydroxyl group nor an ester.

11. The method according to claim 10, wherein the polynorbornene derivative has one of a hexafluoroisopropyl ether group or an acetal group.

12. The method according to claim 10, further comprising selectively exposing the resist composition to radiation at a wavelength of 200 nm or less.

13. The method according to claim 11, further comprising selectively exposing the resist composition to radiation at a wavelength of 200 nm or less.

14. The method according to claim 5, further comprising selectively exposing the resist composition to electron beams or extreme ultraviolet (EUV).

15. The method according to claim 6, further comprising selectively exposing the resist composition to electron beams or extreme ultraviolet (EUV).

16. The method according to claim 7, further comprising selectively exposing the resist composition to electron beams or extreme ultraviolet (EUV).

17. The method according to claim 8, further comprising selectively exposing the resist composition to electron beams or extreme ultraviolet (EUV).

18. The method according to claim 9, further comprising selectively exposing the resist composition to electron beams or extreme ultraviolet (EUV).

19. A method of manufacturing an electronic device comprising the steps of:
preparing a substrate;
forming a first thin film on the substrate;
applying a resist composition to the first thin film; and
developing the resist composition by supercritical carbon dioxide at a pressure of 200 atm or less to form a resist pattern,
wherein the resist composition is at least one selected from the group consisting of:
a resist composition comprising a monodisperse polystyrene having a molecular weight of 3000 or less and a degree of dispersion of 1.5 or less;
a resist composition comprising a nonlinear polymer having a molecular weight of 3000 or less;
a resist composition comprising a fluorine-containing polystyrene, the fluorine-containing polystyrene having a molecular weight of 10000 or less and comprising a styrene monomer, the styrene monomer structurally having one to three fluorine atoms;
a resist composition comprising a fluorine-containing polystyrene, the fluorine-containing polystyrene having a molecular weight of 10000 or less and comprising a styrene monomer, the styrene monomer structurally having one to three fluorine atoms, and the fluorine-containing polystyrene having one to three fluorine atoms on its principal chain or its benzene rings;
a resist composition comprising the fluorine-containing polystyrene, the fluorine-containing polystyrene comprising plural different monomers as a repetitive structure, wherein the total of a molar fraction multiplied by a number of fluorine atoms in the plural different monomers is 3 or less;
a resist composition comprising a polynorbornene derivative having a molecular weight of 5000 or less and containing neither a hydroxyl group nor an ester; and
a resist composition comprising a polynorbornene derivative having a molecular weight of 5000 or less, containing neither a hydroxyl group nor an ester and having one of a hexafluoroisopropyl ether and an acetal.

20. A method of manufacturing an electronic device, the electronic device having a microstructure with a high aspect ratio, the method comprising the steps of:
forming a chromium film on one side of a semiconductor substrate;
forming a metal film an opposing side of the semiconductor substrate;
applying a resist composition to the chromium film to form a resist film;
selectively exposing the resist film to radiation;
developing the exposed resist film to form a desired resist pattern;
depositing a film of nickel on the chromium film exposed from the resist pattern;
removing the resist pattern to form a patterned nickel;
etching the chromium film using the patterned nickel as a mask; and
etching the semiconductor substrate using the chromium film as a mask to form a microstructure comprising the semiconductor substrate and the metals,
wherein the resist composition is at least one selected from the group consisting of:
a resist composition comprising a monodisperse polystyrene having a molecular weight of 3000 or less and a degree of-dispersion of 1.5 or less;
a resist composition comprising a nonlinear polymer having a molecular weight of 3000 or less;
a resist composition comprising a fluorine-containing polystyrene, the fluorine-containing polystyrene having a molecular weight of 10000 or less and comprising a styrene monomer, the styrene monomer having one to three fluorine atoms;
a resist composition comprising a fluorine-containing polystyrene, the fluorine-containing polystyrene having a molecular weight of 10000 or less and comprising a styrene monomer, the styrene monomer having one to three fluorine atoms, and the fluorine-containing polystyrene having the one to three fluorine atoms on its principal chain or its benzene rings;
a resist composition comprising the fluorine-containing polystyrene, the fluorine-containing polystyrene comprising plural different monomers as a repetitive structure, wherein the total of a molar fraction multiplied by a number of fluorine atoms in the plural different monomers is 3 or less;
a resist composition comprising a polynorbornene derivative having a molecular weight of 5000 or less and containing neither a hydroxyl group nor an ester; and
a resist composition comprising a polynorbornene derivative having a molecular weight of 5000 or less, containing neither a hydroxyl group nor an ester and having one of a hexafluoroisopropyl ether or an acetal, and
wherein the step of developing comprises using supercritical carbon dioxide at a pressure of 200 atm or less.
